(19) United States
(12) Patent Application Publication
(10) Pub. No.: US 2024/0269772 A1
(43) Pub. Date: Aug. 15, 2024

(54) LASER WELDING DEVICE AND LASER WELDING METHOD

(71) Applicant: TOYOTA JIDOSHA KABUSHIKI KAISHA, Toyota-shi (JP)

(72) Inventors: Shotaro KUROKAWA, Nisshin-shi (JP); Kohei TAKAHASHI, Nisshin-shi (JP); Tomohiko SEKIGUCHI, Nagakute-shi (JP)

(73) Assignee: TOYOTA JIDOSHA KABUSHIKI KAISHA, Toyota-shi (JP)

(21) Appl. No.: 18/396,962

(22) Filed: Dec. 27, 2023

(30) Foreign Application Priority Data
Feb. 10, 2023 (JP) 2023-018873

(51) Int. Cl. B23K 26/24

(52) U.S. Cl. CPC B23K 26/24

(57) ABSTRACT

There is provided a laser welding device that welds an object to be welded including two or more conductors contacting each other. The laser welding device includes: a welding laser irradiation unit that faces a first face of the object, the welding laser irradiation unit welding the object by irradiating the object with laser light; and a preheating device preheating the object. The preheating device includes a first electrode including a first contact part contacting the first face, and a second electrode including a second contact part contacting a second face of the object, the second face being on an opposite side to the first face. The preheating device heats at least part of the object by heat generated when a current flows in the object via the first electrode and the second electrode.

### CROSS REFERENCE TO RELATED APPLICATIONS

This application is based upon and claims benefit of priority from Japanese Patent Application No. 2023-18873, filed on Feb. 10, 2023, the entire contents of which are incorporated herein by reference.

### BACKGROUND

### Field

The present disclosure relates to a laser welding device and a laser welding method.

### Related Art

There is known a technique of laser welding that prevents cracking of an object to be welded by preheating the object. For example, JP 2010-184248 A discloses preheating an object to be welded by irradiating the object with a light beam.

A preheating method for heating an object to be welded from outside as described in JP 2010-184248 A does not appropriately keep a high temperature of the object due to heat radiation from the surface of the object in some cases.

### SUMMARY

The present disclosure can be achieved as following aspects.

One aspect of the present disclosure provides a laser welding device that welds an object to be welded including two or more conductors contacting each other. This laser welding device includes: a welding laser irradiation unit that faces a first face of the object, the welding laser irradiation unit welding the object by irradiating the object with laser light; and a preheating device preheating the object. the preheating device includes a first electrode including a first contact part contacting the first face, and a second electrode including a second contact part contacting a second face of the object, the second face being on an opposite side to the first face. The preheating device heats at least part of the object by heat generated when a current flows in the object via the first electrode and the second electrode.

### BRIEF DESCRIPTION OF THE DRAWINGS

FIG. 1 is a view illustrating a schematic configuration of a laser welding device according to a first embodiment;

FIG. 2 is a view for describing a target portion according to the first embodiment;

FIG. 3 is a flowchart of welding processing;

FIG. 4 is a view for describing a target portion according to a second embodiment;

FIG. 5 is a view illustrating a target portion according to a third embodiment;

FIG. 6 is a view for describing a target portion according to the third embodiment;

FIG. 7 is a view illustrating a schematic configuration of a laser welding device according to a fourth embodiment;

FIG. 8 is a view for describing an arrangement of electrode pairs according to a fifth embodiment;

FIG. 9 is a view for describing a target portion according to the fifth embodiment;

FIG. 10 is a first view for describing a target portion according to a sixth embodiment;

FIG. 11 is a second view for describing the target portion according to the sixth embodiment; and

FIG. 12 is a view for describing an example of a target portion according to an other embodiment.

### DETAILED DESCRIPTION

### A. First Embodiment

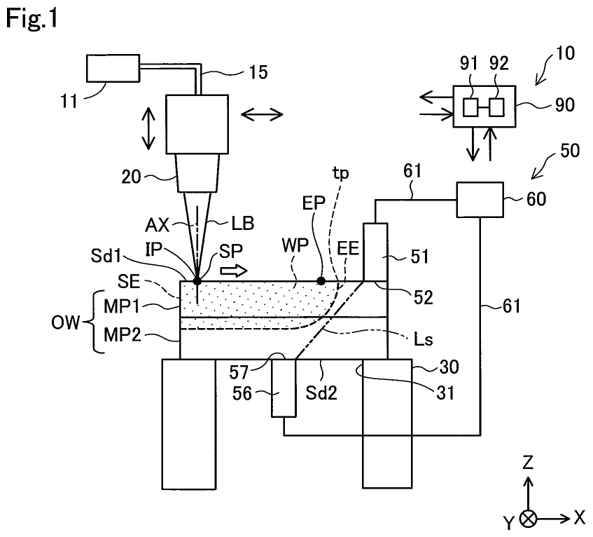

FIG. 1 is a view illustrating a schematic configuration of a laser welding device 10. FIG. 1 illustrates arrows that are orthogonal to each other and go along X, Y, and Z directions. The X, Y, and Z directions are directions that go along an X axis, a Y axis, and a Z axis that are three spatial axes orthogonal to each other, and each include both of one direction that goes along the X axis, the Y axis, or the Z axis, and an opposite direction to the one direction. The X axis and the Y axis are axes that go along a horizontal plane, and the Z axis is an axis that goes along a vertical line. Hereinafter, a +Z direction will be referred to as “upper”, and a −Z direction will be referred to as “lower”.

The laser welding device 10 welds an object OW by irradiating the object OW with laser light LB. The laser welding device 10 includes a laser oscillator 11, a light path 15, a welding laser irradiation unit 20, a stage 30, a preheating device 50, and a control unit 90.

The control unit 90 is configured as a computer including a CPU 91, a storage unit 92, and an input/output interface. The CPU 91 executes programs stored in the storage unit 92 to cause the control unit 90 to implement various functions including a function of preheating the object OW and a function of welding the object OW. Note that, in other embodiments, the control unit 90 may be configured as, for example, a Programmable Logic Controller (PLC). Furthermore, the functions of the control unit 90 may be implemented by a circuit.

The stage 30 supports the object OW. The object OW includes two or more conductors contacting each other and includes a first face Sd1 and a second face Sd2. The second surface Sd2 is a face on an opposite side to the first face Sd1. In the present embodiment, the object OW has a plate shape as a whole. The first face Sd1 is formed by the upper surface of the object OW. The second face Sd2 is formed by the lower surface of the object OW. The object OW may constitute, for example, an entire certain member or product, or may be formed as part of a certain member or product.

In the present embodiment, the object OW includes a first plate member MP1 and a second plate member MP2 as conductors that constitute the object OW. The first plate member MP1 and the second plate member MP2 are each an aluminum plate of a rectangular plate shape. The first plate member MP1 and the second plate member MP2 are mutually laminated in a plate thickness direction of the object OW. The plate thickness direction in the present embodiment is the Z direction. The second plate member MP2 is placed just above the stage 30. The first plate member MP1 is placed just above the second plate member MP2. A gap between the lower surface of the first plate member MP1 and the upper surface of the second plate member MP2 is preferably small to such a degree that a welding defect caused by this gap can be prevented. For example, to improve adhesion of the first plate member MP1 and the second plate member MP2, a jig (not illustrated) that presses the first plate member MP1 against the second plate member MP2 may be installed on the stage 30 as appropriate.

The meaning of that “the first plate member MP1 and the second plate member MP2 are laminated” includes not only that the first plate member MP1 and the second plate member MP2 are laminated in the plate thickness direction completely overlapping each other, but also that the first plate member MP1 and the second plate member MP2 are laminated in the plate thickness direction such that part of the first plate member MP1 and part of the second plate member MP2 overlap. In a case where the first plate member MP1 and the second plate member MP2 are laminated as in the present embodiment, overlapping portions of both of the first plate member MP1 and the second plate member MP2 are welded.

The laser oscillator 11 oscillates the laser light LB. Types of the laser light LB to be oscillated may be an arbitrary type of, for example, a CO₂ laser, a YAG laser, a fiber laser, a disk laser, an excimer laser, or the like. The laser light LB oscillated by the laser oscillator 11 transmits to the welding laser irradiation unit 20 via the light path 15. The light path 15 is, for example, an optical fiber cable or a mirror for transmitting the laser light LB.

The welding laser irradiation unit 20 is disposed facing the first face Sd1 of the object OW. The welding laser irradiation unit 20 condenses the laser light LB transmitted from the laser oscillator 11 and radiates the laser light LB toward the first face Sd1. Furthermore, the welding laser irradiation unit 20 welds the object OW by irradiating a target portion WP of the object OW with the laser light LB. In the present embodiment, an irradiation direction of the laser light LB toward the object OW is the −Z direction. That is, an optical axis AX of the laser light LB radiated from the welding laser irradiation unit 20 goes along the Z direction and is orthogonal to a planar direction of the object OW. In the other embodiments, the optical axis AX may not be orthogonal to the planar direction of the object OW, that is, may incline in the Z direction.

The welding laser irradiation unit 20 according to the present embodiment is configured as a head including a galvano scanner. The welding laser irradiation unit 20 is configured to be able to control a focal position and an irradiation position of the laser light LB radiated on the object OW by changing the angle of a galvano mirror mounted on the galvano scanner under control of the control unit 90. In the present embodiment, the focal position is a position in the Z direction, and the irradiation position is a position in the X direction and the Y direction. Furthermore, the welding laser irradiation unit 20 is configured to be movable with respect to the stage 30. More specifically, the welding laser irradiation unit 20 is fixed to a robot arm (not illustrated) and is moved by an operation of the robot arm under control of the control unit 90. A robot of this robot arm is configured as, for example, a three-axis robot or a six-axis robot. In a case where the robot is configured as the six-axis robot, it is also possible to control the angle of the welding laser irradiation unit 20 with respect to the stage 30. In the other embodiments, the welding laser irradiation unit 20 may be moved by, for example, a horizontal moving mechanism or a lifting mechanism that is configured as an electric actuator.

In FIG. 1, a hatching of a dot pattern is applied to the target portion WP of the object OW. The target portion WP is a portion to be welded in the object OW. More specifically, the target portion WP is a portion that is heated to a melting point or more when irradiated with the laser light LB at a time of welding and is a portion at which a welding mark is formed by welding. The target portion WP includes a portion that is directly irradiated with the laser light LB, and a portion that is melted by heat due to the laser light LB around the irradiated portion. Respective conductors that constitute the object OW are bonded to each other when the target portion WP is welded. In the present embodiment, the target portion WP does not penetrate the object OW in the irradiation direction of the laser light LB. Thus, a welding method that does not penetrate the object OW is also referred to as non-penetration welding. Note that the welding method that penetrates the object OW in the irradiation direction of the laser light LB is also referred to as penetration welding. A portion that is not welded in the object OW, that is, a portion at which a welding mark is not formed will be also referred to as a non-welding portion below.

If welding conditions and the object OW are defined in advance, the shape of the target portion WP can be predicted before welding of the object OW actually starts. The shape of the target portion WP may be predicted based on, for example, a result obtained by welding the same object as that of the object OW under the same conditions in advance or may be predicted based on a simulation result of welding of the object OW.

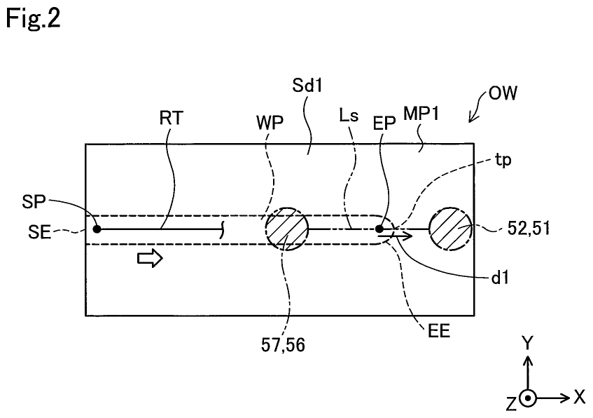

FIG. 2 is a view for describing the target portion WP according to the present embodiment. In the present embodiment, the welding laser irradiation unit 20 is configured to weld the object OW while moving an irradiation position IP of the laser light LB on the object OW. This movement of the irradiation position IP is performed by, for example, changing the angle of the galvano mirror or moving or changing the angle of the welding laser irradiation unit 20 by the robot arm.

In a case where the object OW is welded while the irradiation position IP is moved, the target portion WP includes a start edge part SE and an end edge part EE. The start edge part SE is a rear edge part of the target portion WP in a movement direction of the irradiation position IP and is an edge part corresponding to a start point SP of a movement route RT of the irradiation position IP. The start edge part SE is welded at the start point SP of the movement route RT, that is, at the beginning of welding of the target portion WP. The end edge part EE is a front edge part of the target portion WP in the movement direction of the irradiation position IP, and is an edge part corresponding to an end point EP of the movement route RT. The end edge part EE is welded at the end point EP of the movement route RT, that is, at an end of welding of the target portion WP. Note that the movement route RT is omitted halfway for convenience of illustration in FIG. 2, yet actually extends from the start point SP to the end point EP.

In the present embodiment, the control unit 90 moves the welding laser irradiation unit 20 such that the irradiation position IP linearly moves in the +X direction from the start point SP to the end point EP at the time of welding. Hence, as illustrated in FIG. 2, the movement route RT and the target portion WP in the present embodiment linearly extend along the X direction when seen in the Z direction. Furthermore, the end edge part EE is located at a position in the +X direction of the start edge part SE. More specifically, the target portion WP in the present embodiment extends from an edge in the −X direction of the object OW to a position before the edge in the +X direction. Hence, the start edge part SE is located at the edge in the −X direction of the object OW, and the end edge part EE is located between the start edge part SE in the X direction and the edge in the +X direction of the object OW.

The preheating device 50 preheats the object OW. Details of “preheating” will be described later. As illustrated in FIGS. 1 and 2, the preheating device 50 includes a first electrode 51, a second electrode 56, and a power supply device 60. The first electrode 51 is in contact with the first face Sd1 of the object OW. The second electrode 56 is in contact with the second face Sd2 of the object OW. That is, the first electrode 51 and the second electrode 56 are disposed sandwiching the object OW between the first electrode 51 and the second electrode 56 in the Z direction. Hereinafter, a portion in contact with the first face Sd1 of the first electrode 51 will be also referred to as a first contact part 52, and a portion in contact with the second face Sd2 of the second electrode 56 will be also referred to as a second contact part 57. In FIG. 2, hatchings that go in an upper right direction are applied to an area in which the first contact part 52 is disposed and an area in which the second contact part 57 is disposed. Furthermore, hereinafter, a combination of the first electrode 51 and the second electrode 56 will be also referred to as an electrode pair.

In the present embodiment, the second electrode 56 is disposed in an opening part 31 formed in the stage 30. The opening part 31 is opened facing toward an upper side of the stage 30. In other embodiments, the second electrode 56 may be buried in the stage 30 such that, for example, the second contact part 57 is exposed upward, or disposed above the stage 30. Furthermore, the first electrode 51 and the second electrode 56 may be configured such that the first electrode 51 and the second electrode 56 can be moved with respect to the stage 30 by, for example, the electric actuator or the robot under control of the control unit 90.

In the present embodiment, the first contact part 52 and the second contact part 57 are each made of a material having a higher melting point than that of the object OW. More specifically, since the entire first electrode 51 and second electrode 56 are formed with steel in the present embodiment, the first contact part 52 and the second contact part 57 are formed with steel.

The power supply device 60 is electrically connected to the first electrode 51 and the second electrode 56 with a wiring part 61 interposed therebetween. The power supply device 60 applies the voltage to the first electrode 51 and the second electrode 56 under control of the control unit 90 to cause the current to flow to the object OW through the first contact part 52 and the second contact part 57. That is, in a case where the current is caused to flow to the object OW in this way, at least part of the object OW functions as an electric conduction route that connects between the first electrode 51 and the second electrode 56. When the current flows to the object OW, heat (joule heat) is generated in the object OW. Hereinafter, heat generated in the object OW when the current flows to the object OW through the first contact part 52 and the second contact part 57 as described above will be also referred to as “heat generated by electric conduction”. The preheating device 50 heats the object OW by this heat generated by electric conduction. More specifically, the preheating device 50 according to the present embodiment heats at least part of the end edge part EE by the heat generated by electric conduction. It can be also said that the first electrode 51 and the second electrode 56 are disposed such that at least part of the end edge part EE is heated by the heat generated by electric conduction.

FIG. 1 and FIG. 2 illustrate a line segment Ls. The line segment Ls indicates a virtual line segment of a shortest distance that passes through the inside of the object OW and connects the first contact part 52 and the second contact part 57. A portion near the line segment Ls corresponds to a portion of the object OW at which a large current readily flows through the first electrode 51 and the second electrode 56 compared to other portions. Hence, the portion near the line segment Ls is readily heated to a higher temperature by the heat generated by electric conduction. In the present embodiment, the first electrode 51 and the second electrode 56 are each disposed such that the line segment Ls overlaps at least part of the end edge part EE when seen from a direction that goes from the first face Sd1 to the second face Sd2. That is, in the present embodiment, the line segment Ls overlaps at least part of the end edge part EE when seen from along the Z direction.

In the present embodiment, the first contact part 52 is disposed at a front of a distal end tp of the end edge part EE in the movement direction of the irradiation position IP. The second contact part 57 is disposed at a back of the distal end tp of the end edge part EE in the movement direction of the irradiation position IP. “Being at the front or the back of the end edge part EE in the movement direction of the irradiation position IP” more specifically means being at the front or the back in an end edge direction d1 of the movement route RT. The end edge direction d1 refers to the movement direction of the irradiation position IP when the irradiation position IP is about to reach the end point EP in the movement route RT. That is, the end edge direction d1 matches with a direction of a velocity vector of the irradiation position IP that moves at a position very close to the end point EP on the movement route RT. Accordingly, in a case where, for example, the movement route RT has the linear shape, the end edge direction d1 is a linear direction that travels from the start point SP to the end point EP. Furthermore, in a case where, for example, the movement route RT has the curved shape, the end edge direction d1 is a direction that moves away from a position immediately before the end edge part EE among directions that go along the tangential line of the movement route RT at the end edge part EE.

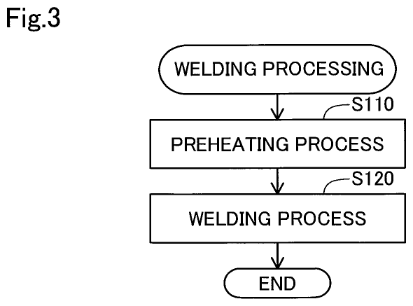

FIG. 3 is a flowchart of welding processing. This flowchart of welding processing refers to a laser welding method according to the present embodiment. The welding processing is executed when, for example, a user performs a predetermined starting operation on the control unit 90 in a state where the object OW is placed on the stage 30, and the first contact part 52 and the second contact part 57 are placed in contact with the first face Sd1 and the second face Sd2, respectively.

In step S110, the control unit 90 executes a preheating process of preheating the object OW. In the preheating process, by causing the current to flow in the object OW via the first electrode 51 and the second electrode 56, at least part of the object OW is heated. More specifically, in step S110, the control unit 90 causes the current to flow in the object OW via the first electrode 51 and the second electrode 56 by controlling the power supply device 60. In step S110 according to the present embodiment, the first electrode 51 and the second electrode 56 are disposed as described above, so that at least part of the end edge part EE and a portion of the target portion WP different from the end edge part EE are heated together with non-welding portions therearound.

In step S120, the control unit 90 executes a welding process. The welding process refers to a process of welding the object OW by irradiating the object OW with the laser light LB from the welding laser irradiation unit 20. In step S120, the control unit 90 controls the welding laser irradiation unit 20 to irradiate the target portion WP with the laser light LB, and cause the welding laser irradiation unit 20 to move along the movement route RT.

As illustrated in FIG. 3, the welding process is executed after the preheating process in the present embodiment. However, the other embodiments are not limited thereto. More specifically, at the time of preheating, heating of a certain portion of the target portion WP may be started before this certain portion is irradiated with the laser light LB. Hence, for example, before welding of the end edge part EE is started, preheating of the end edge part EE may be started after welding of other than the end edge part EE of the target portion WP (e.g., start end part SE) is started. That is, for example, the welding process may be started before the preheating process, or the welding process and the preheating process may be started at the same time. Furthermore, for example, while the certain portion is irradiated with the laser light LB, the preheating device 50 may continue heating this certain portion.

A heating temperature for heating the object OW by the preheating device 50 can be adjusted by, for example, adjusting the magnitude of the current flowing in each electrode or adjusting a continuation time of electric conduction to each electrode. Note that, at the time of preheating, the object OW is heated to a lower temperature than its melting point. Furthermore, the heating temperature of preheating is preferably set to such a high temperature that occurrence of hot cracking of the target portion WP can be prevented at the time of welding. For example, in the present embodiment, the heating temperature of the end edge part EE at the time of preheating is preferably high to such a degree that occurrence of hot cracking at the end edge part EE can be prevented. In this case, the heating temperature may be set taking a preheating completion timing and an irradiation timing of the laser light LB into account. In a case where, for example, a time taken until a certain portion is irradiated with the laser light LB after preheating of this certain portion is completed is short, welding is more likely to be started in a state where a high temperature of the preheated portion is kept compared to a case where this time is longer. Hence, a lower heating temperature may be set in this case. This setting further reduces the time and power consumption required to raise the temperature of the object OW.

According to the laser welding device 10 in the above-described present embodiment, the preheating device 50 includes the first electrode 51 that is in contact with the first face Sd1 of the object OW, and the second electrode 56 that is in contact with the second face Sd2 of the object OW. The preheating device 50 heats the object OW by the heat generated by electric conduction. For example, in another aspect where heat is supplied from an outside of the object OW to heat the object OW unlike the present embodiment, relatively high thermal conductivity of the object OW in particular causes heat radiation from the surface of the object OW to make it difficult to appropriately keep a high temperature of the object OW in some cases. Furthermore, according to such another aspect, for example, increasing a supply amount or a supply time of heat to the object OW to keep the high temperature of the object OW may make the temperature near the surface of the object OW locally too high. In contrast, according to the present embodiment, by causing the current to flow in the object OW via the first electrode 51 and the second electrode 56 at the time of preheating, it is possible to heat at least part of the object OW from the inside of the object OW. Consequently, a possibility increases that it is possible to appropriately keep the high temperature of the object OW by preheating.

Furthermore, in the present embodiment, the first electrode 51 and the second electrode 56 are disposed such that the heat generated by electric conduction heats at least part of the end edge part EE. It is generally known that hot cracking is more likely to occur at the end edge part EE compared to other portions of the target portion WP. According to the present embodiment, it is possible to preheat the vicinity of this end edge part EE using the first electrode 51 and the second electrode 56, so that it is possible to effectively prevent cracking of the object OW.

Furthermore, in the present embodiment, the first electrode 51 and the second electrode 56 are disposed such that the line segment Ls of the shortest distance that passes through the inside of the object OW and connects the first contact part 52 and the second contact part 57 overlaps at least part of the end edge part EE when seen in the Z direction. According to this aspect, it is easy to cause a larger current to flow near the end edge part EE via the first electrode 51 and the second electrode 56 compared to a case where the first electrode 51 and the second electrode 56 are disposed such that the line segment Ls does not overlap the end edge part EE when seen in the Z direction. Consequently, it is possible to efficiently heat the vicinity of the end edge part EE by the heat generated by electric conduction, and more effectively prevent the cracking of the object OW.

Furthermore, in the present embodiment, the first contact part 52 is disposed at the front of the distal end tp of the end edge part EE in the end edge direction d1, and the second contact part 57 is disposed at the back of the end edge part EE in the end edge direction d1. According to such an aspect, the line segment Ls inclines in the plate thickness direction such that the edge on the first face Sd1 side of the line segment Ls is located at the front of the edge on the second face Sd2 side of the line segment Ls in the end edge direction d1. Generally, in a case where welding is executed while the irradiation position IP is moved along the movement route RT, the shape of a cross section along the end edge direction d1 of the end edge part EE and the plate thickness direction is a shape whose distance from the first face Sd1 becomes shorter toward the distal end tp of the end edge part EE as a whole. Consequently, by disposing the first contact part 52 and the second contact part 57 as described above, the possibility increases that it is possible to incline the line segment Ls to go along the shape of the end edge part EE. Consequently, the possibility increases that it is possible to more efficiently heat the vicinity of the end edge part EE using the first electrode 51 and the second electrode 56. Furthermore, according to the above configuration, it is possible to dispose the first electrode 51 without overlapping the movement route RT, that is, at a position that is not irradiated with the laser light LB even when the irradiation position IP is located at any position on the movement route RT. Consequently, it is possible to easily and efficiently heat the vicinity of the end edge part EE until a time immediately before the end point EP is irradiated with the laser light LB. Furthermore, for example, it is possible to heat the end edge part EE likewise even while the end point EP is irradiated with the laser light LB.

Furthermore, in the present embodiment, the first contact part 52 of the first electrode 51 is made of the material having the higher melting point than that of the object OW. According to such an aspect, it is possible to dispose the first contact part 52 closer to the target portion WP compared to a case where the melting point of a member that constitutes the first contact part 52 is the melting point of the object OW or less. Consequently, it is possible to increase the degree of freedom of the arrangement of the first electrode 51. For example, in the present embodiment, the first electrode 51 is easily disposed at a position suitable for heating the vicinity of the end edge part EE. Similarly, in the present embodiment, the second contact part 57 is made of the material having the higher melting point than that of the object OW. Consequently, it is possible to increase the degree of freedom of the arrangement of the second electrode 56.

### B. Second Embodiment

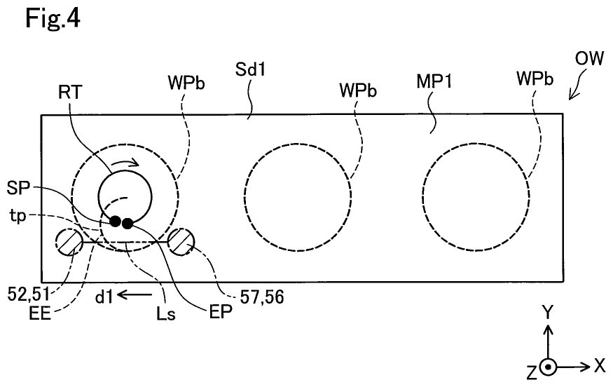

FIG. 4 is a view for describing target portions WPb according to the second embodiment. Unlike the first embodiment, the target portion WPb has a circular shape instead of a linear shape when seen from along the Z direction. Note that, similar to FIG. 2, in FIG. 4, a hatching that goes in the upper right direction is applied to an area in which the first contact part 52 is disposed and an area in which the second contact part 57 is disposed. Parts that are not described in particular in the configuration of the laser welding device 10 according to the second embodiment are the same as those of the first embodiment.

In the present embodiment, the control unit 90 moves the welding laser irradiation unit 20 such that the irradiation position IP moves drawing a circumferential shape at the time of welding. That is, the movement route RT in the present embodiment has the circumferential shape. More specifically, the movement route RT according to the present embodiment is a clockwise route whose start point SP is a position at substantially six o'clock and whose end point EP is a position of substantially six o'clock likewise when seen in the −Z direction. Hence, the end edge direction d1 according to the present embodiment is the −X direction. In the present embodiment, when the irradiation position IP is moved drawing such a circumferential shape at the time of welding, a welding mark is formed clockwise along a circumferential direction of the target portions WPb when seen in the Z direction. Furthermore, after welding is completed, a circular welding mark is left on the object OW when seen in the Z direction. Note that the movement route RT may be, for example, a route through which the irradiation position IP is moved drawing the circumferential shape over a longer distance than one circumference.

In the present embodiment, as illustrated in FIG. 4, the line segment Ls overlaps at least part of the end edge part EE when seen in the Z direction, similarly to the first embodiment. Furthermore, the first contact part 52 is disposed at the front of the distal end tp of the end edge part EE in the end edge direction d1. The second contact part 57 is disposed at the back of the distal end tp of the end edge part EE in the end edge direction d1. Note that the start edge part SE is omitted in FIG. 4 for convenience of illustration.

In a case where the object OW includes the plurality of target portions WPb as illustrated in FIG. 4, for example, a plurality of electrode pairs may be disposed in association with the respective target portions WPb. Furthermore, for example, an electric actuator that moves the first electrode 51 and the second electrode 56 in the X direction or the Y direction may be provided, and this electric actuator may be controlled by the control unit 90 to move the first electrode 51 and the second electrode 56 to positions at which the preheating target portions WPb to be preheated can be heated. FIG. 4 illustrates the three target portions WPb. However, the number of the target portions WPb may be two or may be four or more. Furthermore, the number of the target portions WPb may be one similar to the first embodiment.

The laser welding device 10 according to the above-described second embodiment can also heat the object OW from the inside of the object OW by the heat generated by electric conduction by causing the current to flow in the object OW via the first electrode 51 and the second electrode 56 at the time of preheating. Consequently, the possibility increases that it is possible to appropriately keep the high temperature of the object OW by preheating.

### C. Third Embodiment

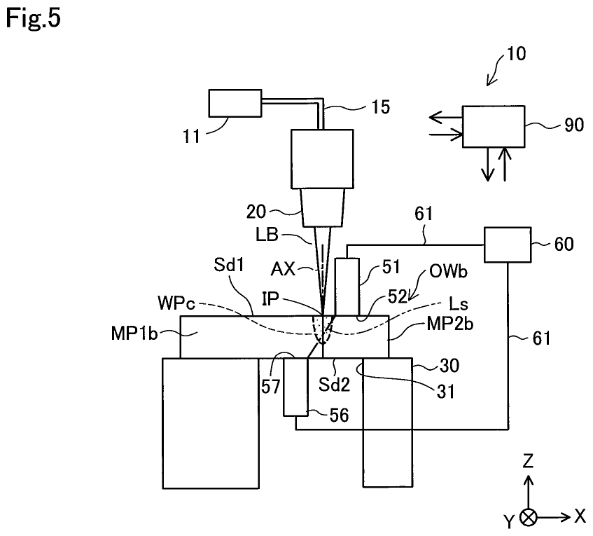

FIG. 5 is a view illustrating an object OWb according to the third embodiment. Unlike the first embodiment, a first plate member MP1b according to the present embodiment is aligned with a second plate member MP2b in a planar direction of the object OWb. Note that, similar to FIG. 1, in FIG. 5, a hatching of a dot pattern is applied to the target portion WPc. Parts that are not described in particular in the configuration of the laser welding device 10 according to the fourth embodiment are the same as those of the first embodiment.

As illustrated in FIG. 5, the first plate member MP1b is disposed in the −X direction of the second plate member MP2b. A gap between the side surface in the +X direction of the first plate member MP1b and the side surface in the −X direction of the second plate member MP2b is preferably small to such a degree that a welding defect caused by this gap can be prevented. Substantially similar to the jig described in the first embodiment, in the present embodiment, too, a jig that presses the first plate member MP1b against the second plate member MP2b may be disposed.

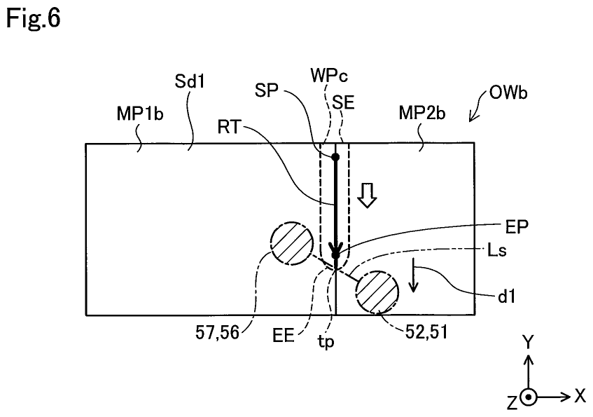

FIG. 6 is a view for describing the target portion WPc according to the third embodiment. Note that, similar to FIG. 2, in FIG. 6, a hatching that goes in the upper right direction is applied to the area in which the first contact part 52 is disposed and the area in which the second contact part 57 is disposed. The target portion WPc according to the present embodiment extends between the first plate member MP1b and the second plate member MP2b along the Y direction. That is, in the present embodiment, the welding laser irradiation unit 20 welds between the first plate member MP1b and the second plate member MP2b. More specifically, in the present embodiment, the control unit 90 moves the irradiation position IP in the Y direction at the time of welding. The end edge direction d1 in the present embodiment is a −Y direction. In the present embodiment, too, as illustrated in FIG. 6, the line segment Ls overlaps at least part of the end edge part EE when seen in the Z direction. Furthermore, the first contact part 52 is disposed at the front of the distal end tp of the end edge part EE in the end edge direction d1. The second contact part 57 is disposed at the back of the distal end tp of the end edge part EE in the end edge direction d1.

The laser welding device 10 according to the above-described third embodiment can also heat the object OWb from the inside of the object OWb by the heat generated by electric conduction by causing the current to flow in the object OWb via the first electrode 51 and the second electrode 56 at the time of preheating. Consequently, the possibility increases that it is possible to appropriately keep the high temperature of the object OWb by preheating.

Note that the laser welding device 10 according to the third embodiment may weld the object OWb while moving the irradiation position IP drawing the circumferential shape similarly as described in the second embodiment, for example.

### D. Fourth Embodiment

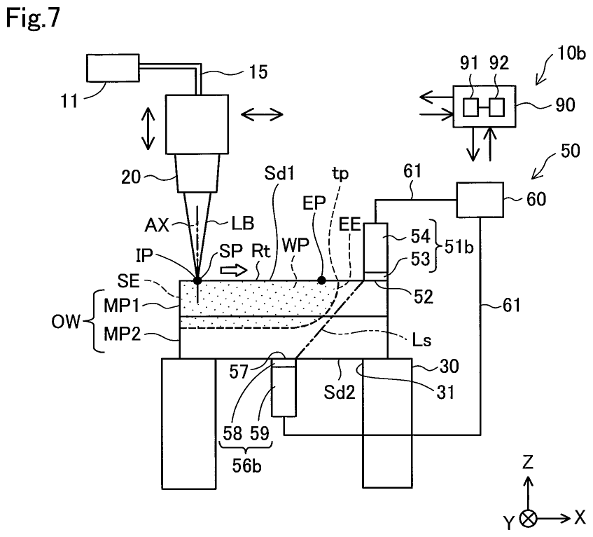

FIG. 7 is a view illustrating a schematic configuration of a laser welding device 10b according to the fourth embodiment. In the fourth embodiment, a first electrode 51b includes a first electrode member 53 and a second electrode member 54 unlike the first embodiment. Furthermore, the second electrode 56b includes a third electrode member 58 and a fourth electrode member 59. Note that, similar to FIG. 1, in FIG. 7, a hatching of a dot pattern is applied to the target portion WP. Parts that are not described in particular in the configuration of the laser welding device 10b according to the fourth embodiment are the same as those of the first embodiment.

The first electrode member 53 is a member of the first electrode 51b that constitutes the first contact part 52. The second electrode member 54 is a member of the first electrode 51b different from that of the first contact part 52. Similarly, the third electrode member 58 is a member of the second electrode 56b that constitutes the second contact part 57. The fourth electrode member 59 is a member different from that of the third electrode member 58.

The first electrode member 53 and the third electrode member 58 are each made of a material having a higher melting point than that of the object OW. The second electrode member 54 is made of a material different from that of the first electrode member 53. Similarly, the fourth electrode member 59 is made of a material different from that of the third electrode member 58. By so doing, it is possible to select materials that form the second electrode member 54 and the fourth electrode member 59 such that the electrical resistances of the first electrode 51 and the second electrode 56 are reduced while securing heat resistance of each contact part to make it possible to dispose each contact part near the target portion WP. In this case, for example, the first electrode member 53 and the third electrode member 58 may be made of steel, and the second electrode member 54 and the fourth electrode member 59 may be made of a material having lower electrical resistivity than that of the steel, such as copper, chromium copper, zirconium copper, copper tungsten, or the like.

The laser welding device 10b according to the above-described fourth embodiment can also heat the object OW from the inside of the object OW by the heat generated by electric conduction by causing the current to flow in the object OW via the first electrode 51b and the second electrode 56b at the time of preheating. Consequently, the possibility increases that it is possible to appropriately keep the high temperature of the object OW by preheating.

Note that, in the other embodiments, for example, only one of the first electrode 51b and the second electrode 56b may be formed by a plurality of members, and the other one may be formed by a single member. Furthermore, the configurations of the first electrode 51b and the second electrode 56b described in the fourth embodiment may be applied to the second embodiment or the third embodiment.

### E. Fifth Embodiment

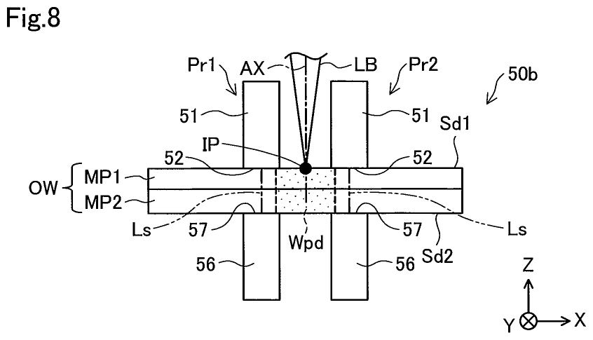

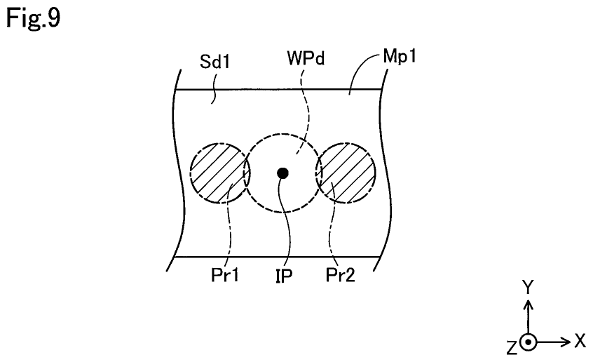

FIG. 8 is a view for describing an arrangement of electrode pairs according to the fifth embodiment. FIG. 9 is a view for describing a target portion WPd according to the fifth embodiment. In FIG. 8, the power supply device 60 and the wiring part 61 are omitted. In the fifth embodiment, a preheating device 50b includes a first pair Pr1 and a second pair Pr2 as the electrode pairs. Furthermore, in the fifth embodiment, the object OW is welded while the irradiation position IP is fixed. Note that, similar to FIG. 1, in FIG. 8, a hatching of a dot pattern is applied to the target portion WPd. Parts that are not described in particular in the configuration of the laser welding device 10 according to the fifth embodiment are the same as those of the first embodiment.

Note that, similar to FIG. 1, in FIG. 8, a hatching of a dot pattern is applied to the target portion WPd. Furthermore, in FIG. 9, a hatching that goes in the upper right direction is applied to an area in which the first pair Pr1 and the second pair Pr2 are disposed when seen in the Z direction. As illustrated in FIG. 8, the first electrode 51 of each electrode pair is located just above the second electrode 56. Hence, the line segment Ls associated with each electrode pair each extends along the Z direction. As illustrated in FIGS. 8 and 9, the first pair Pr1 is disposed at a position in the −X direction of the second pair Pr2.

As illustrated in FIG. 9, the target portion WPd according to the present embodiment has a substantially circular shape whose center is the irradiation position IP when seen in the Z direction. Furthermore, the target portion WPd penetrates the object OW in the Z direction. That is, the welding method according to the present embodiment is penetration welding. As illustrated in FIGS. 8 and 9, the target portion WPd is located between the first pair Pr1 and the second pair Pr2 in the X direction. More specifically, the target portion WPd is located between the two line segments Ls in the X direction.

The laser welding device 10 according to the above-described fifth embodiment can also heat the object OW from the inside of the object OW by the heat generated by electric conduction at the time of preheating. Consequently, the possibility increases that it is possible to appropriately keep the high temperature of the object OW by preheating.

Note that, in, for example, the aspect where the first plate member MP1b and the second plate member MP2b are aligned in the planar direction as described in the third embodiment, the object OW may be welded while the irradiation position IP is fixed similar to the fifth embodiment. Furthermore, the configuration of the first electrode 51b or the second electrode 56b described in the fourth embodiment may be applied to the configuration of the fifth embodiment.

### F. Sixth Embodiment

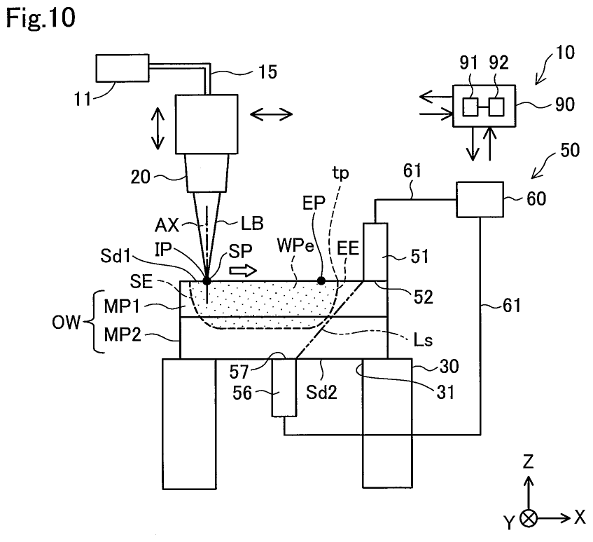

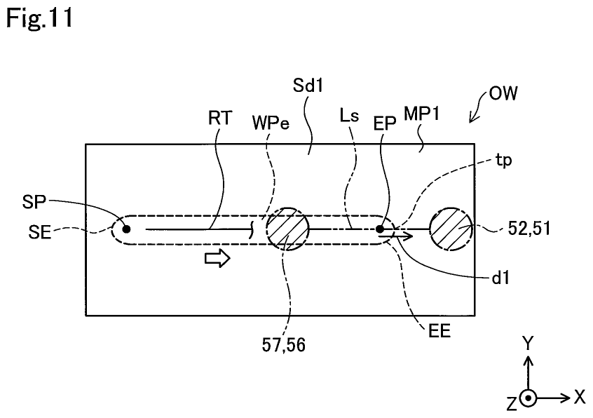

FIG. 10 is a first view for describing a target portion WPe according to the sixth embodiment. FIG. 11 is a second view for describing the target portion WPe according to the sixth embodiment. Note that, similar to FIG. 1, in FIG. 10, a hatching of a dot pattern is applied to the target portion WPe. In the present embodiment, the target portion WPe does not extend to an edge on the −X direction side of the object OW unlike the first embodiment. Hence, the start edge part SE is located at a position in the +X direction compared to the edge in the −X direction of the object OW. Parts that are not described in particular in the configuration of the laser welding device 10 according to the sixth embodiment are the same as those of the first embodiment. Even such a configuration can heat the object OW from the inside of the object OW by the heat generated by electric conduction at the time of preheating. Consequently, the possibility increases that it is possible to appropriately keep the high temperature of the object OW by preheating. Furthermore, similar to the third embodiment, even in the case where, for example, the first plate member MP1 and the second plate member MP2 are aligned in the planar direction, the start edge part SE may not be located at the edge of the object OW.

### G. Other Embodiment

(G1) In the above embodiments, the object OW includes the two conductors, yet may include three or more conductors. Furthermore, the object OW may not have the plate shape as a whole as long as the object OW includes the first face Sd1 and the second face Sd2, and may have, for example, a bar shape or a columnar shape. Furthermore, each member that constitutes the object OW may not have the plate shape, and may have, for example, a bar shape or a columnar shape. Furthermore, the object OW may not be made of aluminum, and may be formed with, for example, other any metals such as iron, magnesium, or various alloys, and may be formed with conductive ceramics. Furthermore, for example, materials of the conductors that constitute the object OW may be different from each other.

(G2) In the above embodiments, the first contact part 52 is disposed at the front of the distal end tp of the end edge part EE in the end edge direction d1. In contrast, the first contact part 52 may be disposed at the same position as that of the distal end tp, or may be disposed at the back of the distal end tp in the end edge direction d1. Furthermore, the second contact part 57 may be disposed at the same position as that of the distal end tp, or may be disposed at the front of the distal end tp in the end edge direction d1. Furthermore, the first contact part 52 may be disposed at the same position as that of the second contact part 57, or may be disposed at the back of the second contact part 57 in the end edge direction d1. Furthermore, both of the first contact part 52 and the second contact part 57 may be disposed at the front of, at the back of, or at the same position as that of the distal end tp in the end edge direction d1.

(G3) In the above embodiments, the first electrode 51 and the second electrode 56 are disposed such that the line segment Ls overlaps at least part of the end edge part EE when seen in the direction that travels from the first face Sd1 to the second face Sd2, that is, when seen in the Z direction. In contrast, the first electrode 51 and the second electrode 56 may be disposed such that the line segment Ls does not overlap the end edge part EE when seen from the Z direction.

(G4) In the above embodiments, the first electrode 51 and the second electrode 56 are disposed such that the end edge part EE is heated by the heat generated by electric conduction. In contrast, the end edge part EE may not be heated by the heat generated by electric conduction, and, for example, the first electrode 51 and the second electrode 56 may be disposed such that only a portion of the target portion WP other than the end edge part EE is heated.

(G5) In the above embodiments, the irradiation position IP may be moved by, for example, moving the object OW with respect to the welding laser irradiation unit 20. In this case, for example, an electric actuator that moves the stage 30 may be provided, and this electric actuator may be controlled by the control unit 90 to move the object OW placed on the stage 30 with respect to the welding laser irradiation unit 20. In this case, for example, the first electrode 51 and the second electrode 56 may be configured to move with respect to the welding laser irradiation unit 20 together with the stage 30.

(G6) In the above embodiments, the movement route RT of the irradiation position IP has the linear shape or the circumferential shape. In contrast, the movement route RT may not have the linear shape or the circumferential shape, and may be, for example, a route having a shape formed by combining a plurality of straight lines, or a route having a shape formed by combining a plurality of curves, or a route having a shape formed by combining straight lines and curves.

(G7) In the above embodiments, the first contact part 52 is made of the material that has the higher melting point than that of the object OW. In contrast, the first contact part 52 may be made of the material that has the melting point equal to or lower than that of the object OW. In this case, the first contact part 52 may be disposed at a position relatively distant from the target portion WP to prevent heat of the laser light LB from influencing the first electrode 51, and prevent the heat from deforming the first electrode 51. Similarly, the second contact part 57 may be made of the material that has the melting point equal to or less than that of the object OW.

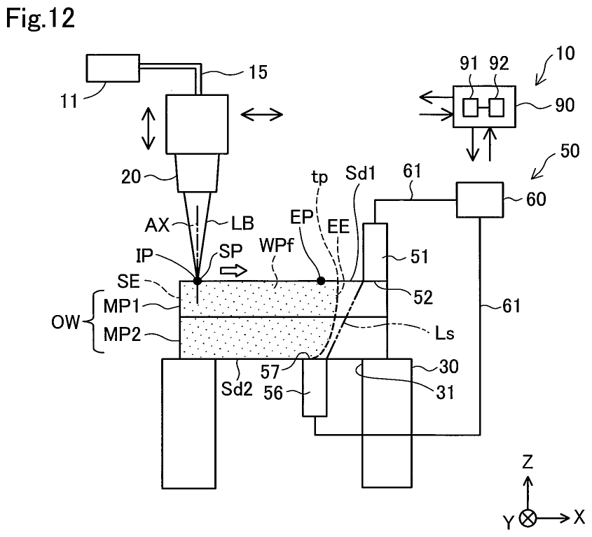

(G8) In the above embodiments, the welding method for welding the object OW while moving the irradiation position IP along the movement route RT may be penetration welding. For example, FIG. 12 is a view for describing an example of a target portion WPf according to the other embodiment. Note that, similar to FIG. 1, in FIG. 12, a hatching of a dot pattern is applied to the target portion WPf. In the example in FIG. 12, the target portion WPf penetrates the object OW in the Z direction. That is, the welding method in the example in FIG. 12 is penetration welding. Even in such an aspect, it is possible to heat the vicinity of the target portion WPf from the inside of the object OW by the heat generated by electric conduction. Note that, in a case where the object OW is subjected to penetration welding as in FIG. 12, the start edge part SE of this target portion WPf may not be located at the edge of the object OW similar to the sixth embodiment.

(G9) In the above embodiments, the arrangement of the first electrode 51 and the second electrode 56 may be determined based on a temperature distribution in the object OW in a case where, for example, the current is caused to flow in the object OW via the first electrode 51 and the second electrode 56. By, for example, simulating the temperature distribution in the object OW by the finite element method, the first electrode 51 and the second electrode 56 may be disposed such that a desired portion of the target portion WP is heated to a higher temperature based on a result of this simulation. More specifically, the first electrode 51 and the second electrode 56 may be disposed such that, for example, the portion to be heated to the higher temperature at the time of the simulation, and the end edge part EE overlap.

The present disclosure is not limited to the above-described embodiments, and can be implemented by various configurations without departing from the gist of the present disclosure. For example, the technical features in the embodiments and their modifications can be replaced or combined as appropriate to solve part or entirety of the above-described problem, or to achieve part or entirety of the above-described effect. Furthermore, unless these technical features are described as indispensable in this description, the technical features can be deleted as appropriate. For example, the present disclosure may be achieved by aspects described below.

(1) A first aspect of the present disclosure provides a laser welding device that welds an object to be welded including two or more conductors contacting each other. This laser welding device includes: a welding laser irradiation unit that faces a first face of the object, the welding laser irradiation unit welding the object by irradiating the object with laser light; and a preheating device preheating the object. the preheating device includes a first electrode including a first contact part contacting the first face, and a second electrode including a second contact part contacting a second face of the object, the second face being on an opposite side to the first face. The preheating device heats at least part of the object by heat generated when a current flows in the object via the first electrode and the second electrode.

According to this aspect, by causing the current to flow in the object via the first contact part contacting the first face of the object and the second contact part contacting the second face at the time of preheating, the object is heated from the inside of the object. Consequently, a possibility increases that it is possible to appropriately keep a high temperature of the object by preheating.

(2) According to the above aspect, the object may include a first plate member and a second plate member as the conductors, and the first plate member and the second plate member may be mutually laminated.

(3) According to the above aspect, the object may include a first plate member and a second plate member as the conductors, the first plate member and the second plate member may be aligned in a planar direction, and the welding laser irradiation unit may weld between the first plate member and the second plate member.

(4) According to the above aspect, the welding laser irradiation unit may be configured to weld the object while moving an irradiation position of the laser light on the object along a predetermined movement route, a portion to be welded in the object may include a start edge part that is welded at a start point of the movement route, and an end edge part that is welded at an end point of the movement route, and the first electrode and the second electrode may be disposed such that the end edge part is heated by the heat. According to this aspect, it is possible to preheat the end edge part using the first electrode and the second electrode. Consequently, it is possible to effectively prevent cracking of the object.

(5) According to the above aspect, the first electrode and the second electrode may be disposed such that a line segment of a shortest distance passing through an inside of the object and connecting the first contact part and the second contact part overlaps at least part of the end edge part when seen in a direction that travels from the first face to the second face. According to this aspect, when seen in the direction that travels from the first face to the second face, a large current readily flows near the end edge part via the first electrode and the second electrode compared to a case where the first electrode and the second electrode are disposed such that the line segment does not overlap the end edge part. Consequently, it is possible to efficiently heat the end edge part using the first electrode and the second electrode, and more effectively prevent the cracking of the object.

(6) According to the above aspect, the first contact part may be disposed at a front of a distal end of the end edge part in a movement direction of the irradiation position, and the second contact part may be disposed at a back of the distal end of the end edge part. According to this aspect, a possibility increases that it is possible to dispose the first electrode and the second electrode such that the line segment of the shortest distance connecting the first electrode and the second electrode goes along the shape of the end edge part. Consequently, the possibility increases that it is possible to more efficiently heat the end edge part using the first electrode and the second electrode.

(7) According to the above aspect, at least one of the first contact part and the second contact part is made of a material having a higher melting point than a melting point of the object. According to this aspect, the first contact part is made of the material having the higher melting point than that of the object, so that it is possible to dispose the first contact part closer to a welding portion compared to a case where the melting point of a material that forms the first contact part is the melting point of the object or less. Similarly, the second contact part is made of the material having the higher melting point than that of the object, so that it is possible to dispose the second contact part closer to the welding portion. Consequently, it is possible to increase the degree of freedom of an arrangement of the first electrode and the second electrode.

The present disclosure can be implemented as various aspects such as a laser welding method and a control method for the laser welding device in addition to the aspect of the above-described laser welding device.

What is claimed is:

1. A laser welding device that welds an object to be welded including two or more conductors contacting each other, the laser welding device comprising:
a welding laser irradiation unit that faces a first face of the object, the welding laser irradiation unit welding the object by irradiating the object with laser light; and
a preheating device preheating the object, wherein
the preheating device includes
a first electrode that includes a first contact part contacting the first face, and
a second electrode that includes a second contact part contacting a second face of the object, the second face being on an opposite side to the first face, and
the preheating device heats at least part of the object by heat generated when a current flows in the object via the first electrode and the second electrode.

2. The laser welding device according to claim 1, wherein
the object includes a first plate member and a second plate member as the conductors, and
the first plate member and the second plate member are mutually laminated.

3. The laser welding device according to claim 1, wherein
the object includes a first plate member and a second plate member as the conductors,
the first plate member and the second plate member are aligned in a planar direction, and
the welding laser irradiation unit welds between the first plate member and the second plate member.

4. The laser welding device according to claim 1, wherein
the welding laser irradiation unit is configured to weld the object while moving an irradiation position of the laser light on the object along a predetermined movement route,
a portion to be welded in the object includes a start edge part that is welded at a start point of the movement route, and an end edge part that is welded at an end point of the movement route, and
the first electrode and the second electrode are disposed such that the end edge part is heated by the heat.

5. The laser welding device according to claim 4, wherein the first electrode and the second electrode are disposed such that a line segment of a shortest distance passing through an inside of the object and connecting the first contact part and the second contact part overlaps at least part of the end edge part when seen in a direction that travels from the first face to the second face.

6. The laser welding device according to claim 5, wherein
the first contact part is disposed at a front of a distal end of the end edge part in a movement direction of the irradiation position, and
the second contact part is disposed at a back of the distal end of the end edge part.

7. The laser welding device according to claim 1, wherein at least one of the first contact part and the second contact part is made of a material having a higher melting point than a melting point of the object.

8. A laser welding method for welding an object to be welded including two or more conductors contacting each other, the laser welding method comprising:
a preheating step of preheating the object; and
a welding step of welding the object by irradiating a welding portion of the object with laser light from a welding laser irradiation unit disposed facing a first face of the object,
wherein in the preheating step, at least part of the object is heated by causing a current to flow in the object via a first electrode contacting the first face, and a second electrode contacting a second face of the object, the second face being on an opposite side to the first face.
